(19) United States
(12) Patent Application Publication
(10) Pub. No.: US 2007/0045241 A1
(43) Pub. Date: Mar. 1, 2007

(54) CONTACT START PLASMA TORCH AND METHOD OF OPERATION

(76) Inventors: Joseph C. Schneider, Menasha, WI (US); Kirk L. Deheck, Saukville, WI (US); Timothy J. Ziolkowski, Grafton, WI (US)

Correspondence Address: ZIOLKOWSKI PATENT SOLUTIONS GROUP, SC (ITW), 136 S WISCONSIN ST, PORT WASHINGTON, WI, 53074, US

(21) Appl. No.: 11/162,099

(22) Filed: Aug. 29, 2005

(51) Int. Cl. B23K 9/00; B23K 9/02

(52) U.S. Cl. 219/121.36

(57) ABSTRACT

A contact start plasma torch has a shuttle element disposed between a cathodic component and an anodic component. The shuttle element is movable between a first position and a second position and is maintained in the first position during an idle mode and a cutting mode. When the shuttle element is in the first position, a separation is maintained between the cathodic component and the anodic component of the plasma torch. The shuttle element momentarily bridgingly connects the cathodic component and the anodic component when it is located in the second position and initiates a plasma arc therebetween as it returns to the first position.

### BACKGROUND OF THE INVENTION

The present invention relates generally to plasma cutting systems and, more particularly, to a plasma torch for use with such systems.

Plasma cutting is a process in which an electric arc and plasma gas are used for cutting a workpiece. Plasma cutters typically include a power source, an air supply, and a torch. The torch, or plasma torch, is used to create and maintain the plasma arc that performs the cutting. A plasma cutting power source receives an input voltage from a transmission power receptacle or generator and provides output power to a pair of output terminals, one of which is connected to the plasma torch and the other of which is connected to the workpiece. An air supply is used with most plasma cutters to carry and propel the arc from the tip assembly of the plasma torch to the workpiece and also helps cool the torch.

The cutting process is typically initiated through one of contact starting, high frequency starting, or high voltage starting. Generally, in contact start plasma cutters, a movable or fixed electrode or consumable serves as a cathode and a fixed or movable nozzle or tip serves as an anode. The cathodic and the anodic component are biased to remain in contact until an arc is desired. Biasing of the components into contact ensures that the components of the torch are in the appropriate position when a pilot arc is desired. When an arc is desired, a pilot arc power is introduced across the moveable components and when a separation is created therebetween, a pilot arc is generated. As the pilot arc is established, air is forced past the pilot arc whereby it is heated and ionized to form a plasma jet that is forced out of the torch through an opening in the nozzle. The air aids in extending the arc to the workpiece thereby forming a cutting arc and initiating the cutting process.

Generally, the separation of the components is achieved by overcoming a bias that retains the components in contact with one another. Once the anodic and cathodic components have been separated and a pilot arc has been achieved, the components remain separated for the duration of a particular cutting process. When the plasma torch is positioned in close proximity to a work piece, the pilot arc transfers to the workpiece and establishes the cutting arc. During a cutting process, the contact bias remains overcome such that the cathodic and anodic components remain separated for the duration that the torch maintains any arc. Once a cutting process has been completed, the components are returned to an idle position wherein the cathodic and anodic components are in contact with one another.

It would be advantageous to design a plasma cutting system having a contact start plasma torch which does not have a tip or nozzle in contact with an electrode and only momentarily electrically connects the cathodic and anodic components of the plasma torch as required to generate a pilot arc.

### BRIEF DESCRIPTION OF THE INVENTION

The present invention provides a system and method that overcomes the aforementioned drawbacks. Specifically, a plasma torch has an anodic component, a cathodic component, and a contactor moveably disposed therebetween. The contactor is biased to a rest position wherein the contactor maintains physical separation of the cathodic and anodic components. To initiate a pilot arc, the contactor is moved, against the bias, into bridging contact with the cathodic component and the anodic component. The contactor then returns to the rest position thereby generating a pilot arc.

Therefore, in accordance with one aspect of the present invention, a plasma torch having an electrode, a nozzle, and a shuttle element is disclosed. The nozzle is positioned about the electrode and the shuttle element is disposed therebetween. The shuttle element is movable between a first position and a second position. When located in the first position, the shuttle element is separated from at least one of the nozzle and the electrode and, when momentarily located in the second position, the shuttle element contacts the nozzle and the electrode. The plasma torch includes a biasing means constructed to bias the shuttle element to the first position during an idle mode and a cutting mode of the plasma torch. The shuttle element is momentarily movable to the second position when generation of a pilot arc is desired.

According to another aspect of the present invention, a plasma cutting system is disclosed. The plasma cutting system has a plasma torch connected to a power source constructed to generate a power signal suitable for plasma cutting applications. The plasma torch has a cathodic component having a fixed-position, an anodic component having a fixed-position, and a separator movably disposed between the cathodic component and the anodic component. A first biasing means is connected to the plasma torch and is constructed to bias the separator out of mutual contact with the cathodic component and the anodic component. A second biasing means is connected to the plasma torch and is constructed to overcome the first biasing means and move the separator into mutual contact with the cathodic component and the anodic component.

According to a further aspect of the present invention, a method of initiating a plasma arc is disclosed that includes the steps of biasing a shuttle element housed in a plasma torch to maintain a separation between a cathode and an anode, overcoming the bias to connect the shuttle element to the cathode and the anode, and returning the shuttle element to the biased position to generate a plasma arc.

Various other features and advantages of the present invention will be made apparent from the following detailed description and the drawings.

### BRIEF DESCRIPTION OF THE DRAWINGS

The drawings illustrate four alternate embodiments presently contemplated for carrying out the invention.

In the drawings:

FIG. 1 is a perspective view of a plasma cutting system incorporating the present invention.

FIG. 2 is an elevational view of the torch tip assembly shown in FIG. 1.

FIG. 3 is a cross-sectional view of one embodiment of the torch tip assembly shown in FIG. 2 and shows a shuttle element in a first position.

FIG. 4 shows the torch tip assembly shown in FIG. 3 with the shuttle element moved to a second position.

FIG. 5 shows a cross-sectional view of another embodiment of the torch tip assembly shown in FIG. 2 and shows a shuttle element in a first position.

FIG. 6 shows the torch tip assembly shown in FIG. 5 with the shuttle element moved to a second position.

FIG. 7 shows a cross-sectional view of a further embodiment of the torch tip assembly shown in FIG. 2 and shows the shuttle element in a first position.

FIG. 8 shows the plasma torch shown in FIG. 7 with the shuttle element moved to a second position.

FIG. 9 shows a cross-sectional view of yet another embodiment of the torch tip assembly shown in FIG. 2 and shows a shuttle element in a first position.

FIG. 10 shows the torch tip assembly shown in FIG. 9 with the shuttle element moved to a second position.

FIG. 11 shows an exemplary plasma cutting system according to which each of the plasma torches shown in FIGS. 2-9 is operated.

### DETAILED DESCRIPTION OF THE PREFERRED EMBODIMENT

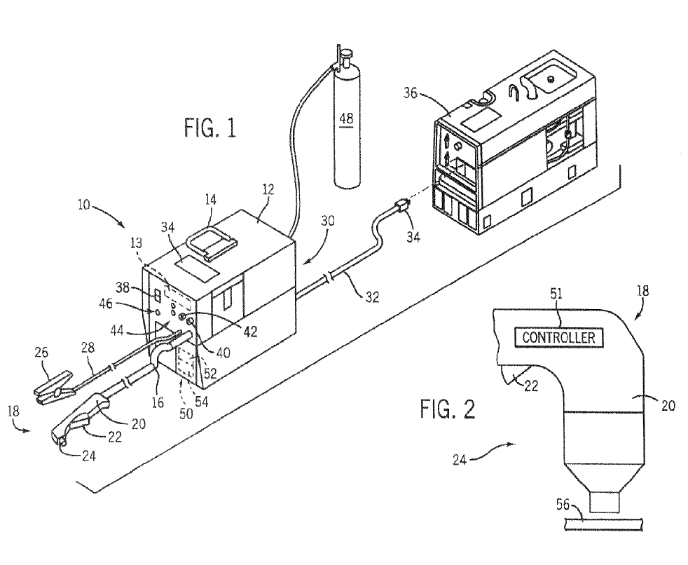

FIG. 1 shows a plasma cutting system 10 according to the present invention. Plasma cutting system 10 is a high voltage system with open circuit output voltages that typically range from approximately 230 Volts Direct Current (VDC) to over 300 VDC. Plasma cutting system 10 includes a power source 12 to condition raw power and generate a power signal suitable for plasma cutting applications. Power source 12 includes a processor 13 that receives operational feedback and monitors the operation of a plasma cutting system 10. Power source 12 includes a handle 14 to effectuate transportation from one site to another. A cable 16 connects a torch assembly 18 to power source 12. Cable 16 provides torch 18 with power and compressed air or gas, and also serves as a communications link between torch 18 and power source 12. Torch 18 includes a torch body, or handle portion 20 having a trigger 22 thereon and a tip assembly 24 extending therefrom. Although shown as attached to torch 18, it understood and within the scope of the claims that trigger 22 be connected to power source 12 or otherwise remotely positioned relative to torch 18.

Also connected to power source 12 is a work clamp 26 designed to connect to a workpiece (not shown) to be cut and provide a grounding or return path. A cable 28 connects work clamp 26 to power source 12 and provides the return path, or grounding path, for the cutting current from torch 18 through the workpiece and work clamp 26. Extending from a rear portion 30 of power source 12 is a power cable 32 having a plug 34 for connecting power source 12 to either a portable power supply 36 or a transmission line power receptacle (not shown). Power source 12 includes an ON/OFF switch 38 and may also include amperage and air pressure regulation controls 40, 42, indicator lights 44, and a pressure gauge 46.

To effectuate cutting, torch 18 is positioned in close proximity to the workpiece connected to clamp 26. A user then activates trigger 22 on torch 18 to deliver electrical power and compressed air to tip assembly 24 of torch 18 to initiate a pilot arc and plasma jet. Shortly thereafter, a cutting arc is established as the user moves the torch to the workpiece and at least a portion of the pilot arc extends between torch 18 and a workpiece. The arc transfers from an electrode to the workpiece through tip assembly 24. The user may then cut the workpiece by moving torch 18 across the workpiece. The user may adjust the speed of the cut to reduce spark splatter and provide a more-penetrating cut by adjusting amperage and/or air pressure. Gas is supplied to torch 18 from a pressurized gas source 48 connected to power source 12. Alternatively, gas could be supplied to torch 18 from an internal or an external air compressor or gas source.

Power source 12 includes a controller 50 electrically connected to plasma cutting torch 18. Controller 50 includes a pilot arc circuit 52 and a cutting arc circuit 54. Controller 50 is electrically connected to trigger 22 of cutting torch 18 and processor 13. Initial actuation of trigger 22 enables pilot arc circuit 52. Pilot arc circuit 52 instructs power source 12 to provide a power signal sufficient for tip assembly 24 to generate a pilot arc. After generation of a pilot arc, cutting arc circuit 54 enables communication of cutting arc power from power source 12 to tip assembly 24 of torch 18 and therefrom to a workpiece 56. Understandably, although controller 50, pilot arc circuit 52, and cutting arc circuit 54 are shown attached to power source 12, other locations such as torch assembly 18 are envisioned and within the scope of the claims.

Referring now to FIG. 2, tip assembly 24 is removeably attached to handle portion 20 of plasma cutting torch 18. A biasing means controller 51 is attached to plasma cutting torch 18 and communicates with controller 50 of power source 12. As described further with respect to FIG. 11, biasing means controller 51 controls operation of a shuttle element of plasma torch 18. It is further understood that biasing means controller 51, rather than being integrated into plasma torch 18, could be located in other positions such as power source 12.

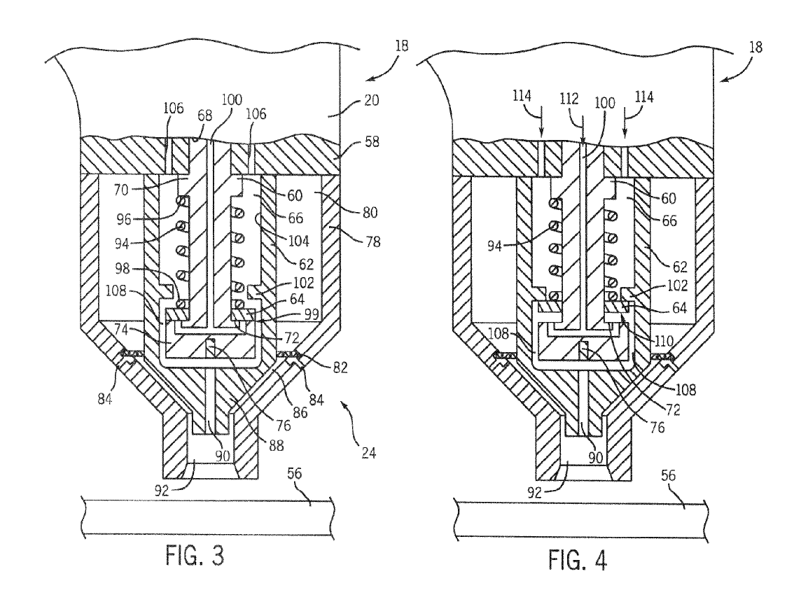

FIG. 3 shows a partial cross-sectional view of one embodiment of tip assembly 24 according to the present invention. As shown in FIG. 3, tip assembly 24 removably engages an end 58 of torch body 20. Tip assembly 24 includes a cathodic component, or electrode 60, an anodic component, or nozzle 62, and a shuttle element 64 disposed therebetween. Electrode 60 is centrally disposed within a gas chamber 66 and has a base 68 that electronically communicates with power source 12 through handle portion 20 of torch assembly 18. Electrode 60 has a shoulder 70 formed proximate base 68 and a ledge 72 formed proximate a tip 74 of electrode 60. Tip 74 of electrode 60 includes an insert 76 generally centrally disposed therein. Preferably, insert 76 is formed of a hafnium or zirconium material. Insert 76 supports a cutting arc and is resistive to deterioration associated with the support of the cutting arc.

A cup or cap 78 is positioned about nozzle 62 and defines a plasma/cooling gas chamber 80 therebetween. A swirl ring 82 is positioned in gas chamber 80 and directs a flow of gas helically about nozzle 62. Cap 78 preferably includes a plurality of bleed ports or vents 84 formed radially therethrough. However, such vents are not necessary to practice the invention. A gas passage 86 extends between cap 78 and a tapered end 88 of nozzle 62. An orifice 90 is centrally positioned through tapered end 88 of nozzle 62 and generally aligned with insert 76. An opening 92 is formed through cap 78 and is generally aligned with orifice 90 of nozzle 62. During operation of plasma torch 18, a cutting arc and plasma gas exits torch assembly 18 through orifice 90 of nozzle 62 and opening 92 of cap 78 and is directed to workpiece 56.

Electrode 60 and nozzle 62 have fixed relative positions. A biasing means, or spring 94, extends between shoulder 70 and ledge 72 of electrode 60. A first end 96 of spring 94 engages shoulder 70 of electrode 60 and a second end 98 of spring 94 engages shuttle element 64. Spring 94 biases shuttle element 64 to a first position 99 wherein shuttle element 64 contacts ledge 72. A gas path 100 is formed through electrode 60 and is in fluid communication with gas source 48. Gas path 100 terminates at ledge 72 of electrode 60. Passage of gas through gas path 100 overcomes the bias of spring 94 and momentarily forces shuttle element 64 into contact with a ridge 102 formed about an interior surface 104 of nozzle 62. A plurality of gas tubes 106 extend through torch assembly 18 and fluidly connect gas chamber 66 to gas source 48. When the flow of gas through gas path 100 is suspended, shuttle element 64 moves away from ridge 102 forming a pilot arc therebetween. Gas in gas chamber 66 flows through an arc passage 108 formed between electrode 60 and nozzle 62 and carries the pilot arc therewith. The pilot arc continues to travel through arc passage 108 until it reaches insert 76. Once the pilot arc has reached insert 76, a cutting arc can be established when opening 92 of cap 78 is positioned in relatively close proximity to workpiece 56.

FIG. 4 shows shuttle element 64 moved to a second position 110 with the introduction of a gas flow (indicated by arrow 112) through gas path 100. Gas flow 112 overcomes the bias of spring 94, which biases shuttle element 64 into contact with ledge 72, and also overcomes any gas pressure bias that may exist in gas chamber 66, and forces shuttle element 64 into contact with ridge 102. A pilot arc power is communicated between electrode 60 and nozzle 62 via shuttle element 64 when pilot arc circuit 52, as shown in FIG. 2, is enabled and shuttle element 64 is momentarily located in second position 110. Suspending gas flow 112, or increasing gas flow, indicated by arrows 114, through gas tubes 106, returns shuttle element 64 to first position 99 shown in FIG. 3. The return of shuttle element 64 to first position 99 from second position 110 creates a pilot arc between shuttle element 64 and nozzle 62. Gas flow 114 carries the pilot arc through arc passages 108 and toward insert 76. The arc heats the gas passing therealong and generates a plasma gas. When torch assembly 18 is positioned proximate workpiece 56, the pilot arc extends thereto through orifice 90 and opening 92 and forms a cutting arc between workpiece 56 and insert 76. The combination of the cutting arc and the plasma gas cooperate to perform a cutting-type process. As such, during idle and cutting operation of plasma torch 18, shuttle element 64 is biased out of contact with nozzle 62 thereby forming an “open” circuit condition between electrode 60 and nozzle 62.

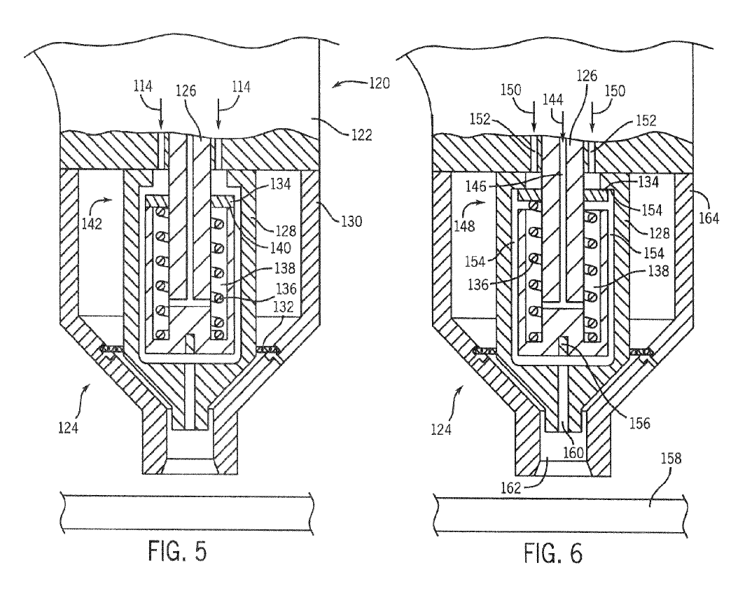

FIGS. 5 and 6 show an alternate embodiment of a plasma torch assembly according to the present invention. As shown in FIG. 5, a plasma torch assembly 120 includes a torch body or handle portion 122. Plasma torch assembly 120 includes a tip assembly 124 having an electrode 126, a nozzle 128 positioned about electrode 126, a cap 130, and a swirl ring 132 positioned between cap 130 and nozzle 128. A shuttle element 134 is movably disposed between electrode 126 and nozzle 128. The positions of electrode 126 and nozzle 128 are fixed relative to one another. Electrode 126 and nozzle 128 are electrically connected to power source 12 through torch body 122. A biasing means 136 is disposed in a cavity 138 of electrode 126 and secured to shuttle element 134 and electrode 126. Biasing means 136 biases shuttle element 134 against a ledge 140 of electrode 126. Shuttle element 134 maintains a first position 142 during non-operation of torch assembly 120 and during cutting operation of plasma torch assembly 120.

As shown in FIG. 6, when a flow of gas, indicated by arrow 144, is introduced to a gas path 146 formed through electrode 126, shuttle element 134 moves axially along electrode 126 to momentarily maintain a second position 148. Gas flow 144 enters cavity 138 and is sufficient to overcome biasing means 136. When flow of gas 144 is suspended, or a flow of gas, indicated by arrows 150, is introduced to a pair of gas tubes 152, shuttle element 134 returns to first position 142 and a pilot arc is generated between shuttle element 134 and a ledge 154 of nozzle 128. Gas flow 150 carries the pilot arc along an arc passage 154 between electrode 126 and nozzle 128 to an insert 156. When torch assembly 120 is positioned in close proximity to a workpiece 158, the pilot arc extends thereto. The pilot arc passes through an orifice 160 formed in nozzle 128 and an opening 162 formed in a cap 164 positioned about nozzle 128 and establishes a cutting arc between workpiece 158 and insert 156. As such, shuttle element 134 is located in first position 142 during non-use and cutting use of plasma torch assembly, and is momentarily located in second position 148 only when a pilot arc is desired. As such, during initial arc generation, shuttle element 134 moves from first position 142 to second position 148 and returns to first position 142 in a shuttle-type fashion.

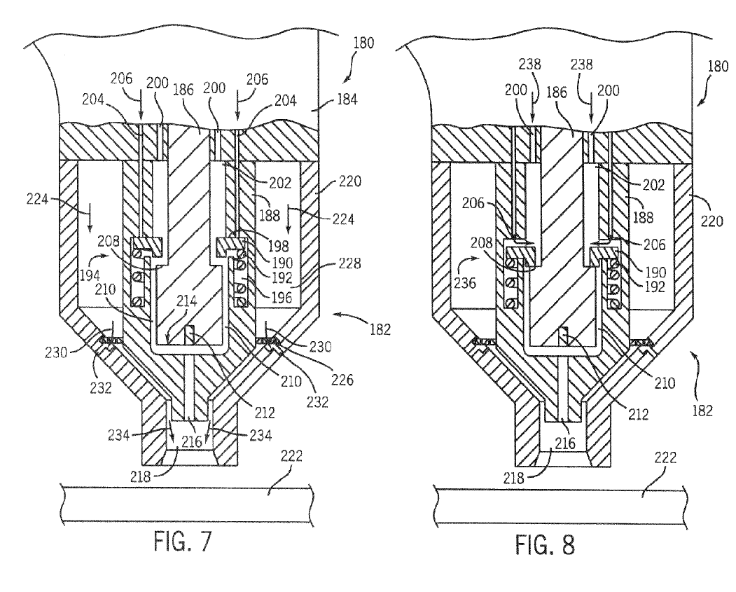

FIGS. 7 and 8 show another alternate embodiment of a plasma torch assembly according to the present invention. As shown in FIG. 7, a plasma torch assembly 180 includes a tip assembly 182 removably connected to a torch body, or handle portion 184. An electrode 186 is electrically connected to power source 12 through handle portion 184. A nozzle 188 is positioned about electrode 186 and includes a shuttle element 190 slideably attached thereto. A biasing means, or spring 192 biases shuttle element 190 to a first position 194 and out of contact with electrode 186. Spring 192 is disposed in a cavity 196 of nozzle 188 and biases shuttle element 190 into contact with a ridge 198 of nozzle 188.

A pair of gas tubes 200 fluidly connect a gas chamber 202 of tip assembly 182 with a gas source through handle position 184. A plurality of gas paths 204 extend through nozzle 188 and are fluidly connected to a gas source through handle portion 184. Gas paths 204 terminate at ridge 198 of nozzle 188 and a gas flow, indicated by arrows 206, overcomes the bias of spring 192 and momentarily forces shuttle element 190 into contact with a ledge 208 of electrode 186. An arc passage 210 is formed between electrode 186 and nozzle 188. Termination of gas flow 206 allows shuttle element 190 to return to first position 194 and initiates a pilot arc between shuttle element 190 and ledge 208. The pilot arc is carried with the flow of gas from gas chamber 202 through arc passage 210 and toward an insert 212 disposed in an end 214 of electrode 186.

The pilot arc passes through an orifice 216 formed in nozzle 188 and an opening 218 formed in a cap 220 positioned about nozzle 188. When tip assembly 182 is positioned in close proximity to a workpiece 222, the pilot arc extends between insert 212 and workpiece 222 and establishes a cutting arc therebetween. A gas flow, indicated by arrow 224, passes through a swirl ring 226 from a gas cavity 228 formed between cap 220 and nozzle 188. A first portion 230 of gas flow 224 exits cap 220 at a plurality of bleed ports or vents 232 and a second portion 234 of gas flow 224 passes to opening 218 and generally surrounds a cutting arc passing therethrough.

As shown in FIG. 8, shuttle element 190 is movable to a second position 236 as gas flow 206 passes into gas chamber 202. Shuttle element 190, when located in second position 236, electrically connects nozzle 188 and electrode 186 via shuttle element 190. The suspension of gas flow 206 allows spring 192 to return shuttle element 190 to first position 194 shown in FIG. 7 and initiates a pilot arc between shuttle element 190 and ledge 208 of electrode 186. A gas flow, indicated by arrows 238, from gas tubes 200 enters gas chamber 202 between electrode 186 and nozzle 188. When shuttle element 190 returns to first position 194, gas flow 238 carries the pilot arc formed between ledge 208 and shuttle element 190 through arc passage 210 and toward insert 212. The pilot arc formed about insert 212 extends from tip assembly 182 through orifice 216 of nozzle 188 and opening 218 of cap 220 thereby establishing a cutting arc with workpiece 222. Shuttle element 190 remains in first position 194 during idle and cutting operation of plasma torch assembly 180 and is momentarily located in second position 236 only when initiation of a pilot arc is desired.

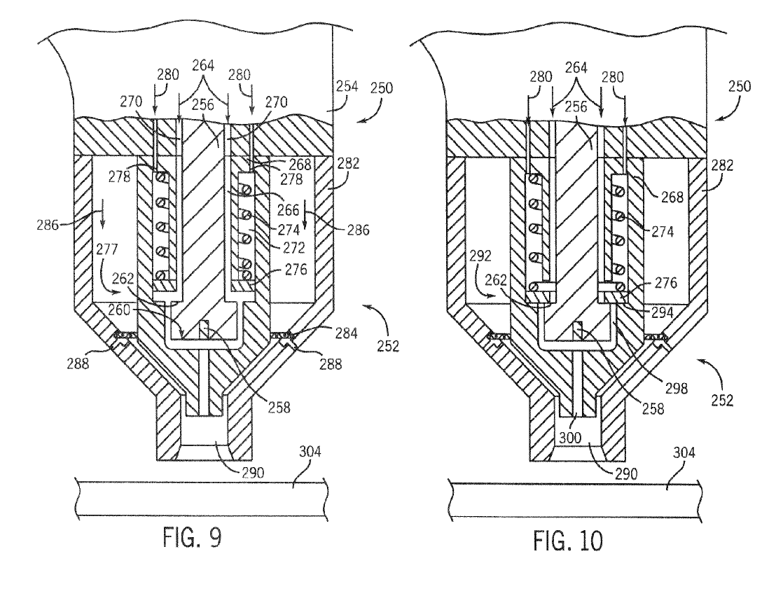

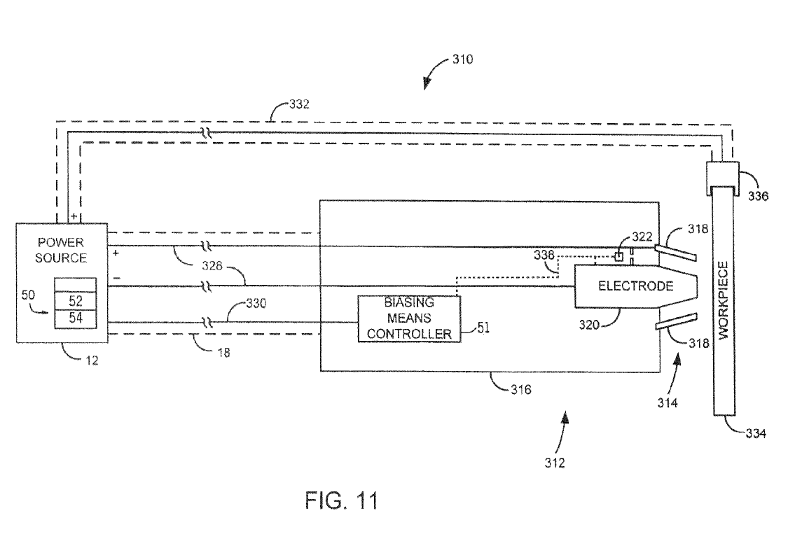

FIGS. 9 and 10 show yet another embodiment of a plasma torch assembly according to the present invention. As shown in FIG. 9, a plasma torch assembly 250 includes a tip assembly 252 removably connected to a torch body or handle portion 254. An electrode 256 is electrically connected to power source 12 and includes an insert 258 disposed in an end 260 thereof. A ledge 262 is formed on electrode 256 proximate end 260. A gas flow, indicted by arrows 264, fluidly connects a gas chamber 266 formed between electrode 256 and a nozzle 268 to a gas source via a plurality of gas tubes 270. Nozzle 268 includes a cavity 272 formed therein. A biasing means or spring 274 is disposed in cavity 272 and secures a shuttle element 276 to nozzle 268. Spring 274 biases shuttle element 276 to a first position 277. A plurality of gas paths 278 pass through nozzle 268 and fluidly connect cavity 272 to a gas source. A flow of gas, indicated by arrows 280, through gas paths 278 pressurizes cavity 272 when gas is introduced thereto. A cap 282 is positioned about nozzle 268 and includes a swirl ring 284 positioned therebetween. A gas flow, indicated by arrows 286, flows between cap 282 and nozzle 268 and through swirl ring 284. Gas flow 286 exits cap 282 at a plurality of ports 288 and an opening 290 formed through cap 282.

As shown in FIG. 10, shuttle element 276 is movable to a second position 292. When temporarily located in second position 292, shuttle element 276 overcomes the bias of spring 274 and moves into contact with a ridge 294 of nozzle 268 and ledge 262 of electrode 256. Gas flow 280 is sufficient to allow shuttle element 276 to stretch spring 274 and engage ridge 294 and ledge 262. As gas flow 280 is suspended, spring 274 returns shuttle element 276 to first position 277 and a pilot arc is established between shuttle element 276 and ledge 262 of electrode 256. As shuttle element 276 returns to first position 277, gas flow 264 passes between shuttle element 276 and electrode 256 and carries the pilot arc through an arc passage 298 and towards insert 258. The pilot arc passes through an orifice 300 formed in nozzle 268 and exits plasma torch assembly 250 through an opening 290 formed in cap 282. The pilot arc extends between insert 258 and a workpiece 304 thereby establishing a cutting arc therebetween. Such a construction provides a plasma torch assembly having a shuttle element which shuttles between a position out of mutual contact with both the electrode and nozzle during cutting operation and idle, or non-use, operation of the plasma torch assembly, and a momentary position of bridging contact between the nozzle and electrode for pilot arc generation.

Each embodiment includes a nozzle and an electrode having a relatively fixed location. The embodiments shown in FIGS. 3-6 provide a plasma torch assembly having a shuttle element biased into contact with the electrode during non-use and cutting operation of the plasma torch. Biasing means 94 of torch assembly 18, shown in FIGS. 3 and 4, is preloaded in compression to bias shuttle element 64 into contact with electrode 60. Comparatively, biasing means 136 of torch assembly 120, shown in FIGS. 5 and 6, is preloaded in tension to bias shuttle element 134 into contact with electrode 126. The embodiments shown in FIGS. 7-10 provide a plasma torch assembly having a shuttle element biased into contact with the nozzle during non-use and cutting operation of the plasma torch. Biasing means 192 of torch assembly 180, shown in FIGS. 7 and 8, is preloaded in compression to bias shuttle element 190 into contact with nozzle 188. Comparatively, biasing means 274 of torch assembly 250, shown in FIGS. 9 and 10, is preloaded in tension to bias shuttle element 276 into contact with nozzle 268. Regardless of which embodiment is practiced, the shuttle element is biased out of mutual contact with the cathodic and anodic component of the torch assembly during both non-use of the torch assembly and during cutting operation of the torch assembly. Additionally, although each embodiment includes a spring as the biasing means, understandably other biasing means, such as a gas pressure, solenoid control, or other mechanical actuators are envisioned and within the scope of the claims. Similarly, although each embodiment has a gas flow as the overcoming bias means, a spring, solenoid control, or other mechanical actuator could equally perform this overcoming bias means and are also within the scope of the claims.

FIG. 11 shows a graphic representation of an exemplary plasma cutting system usable with any of the above torch tip assembly embodiments. Plasma cutting system 310 includes a power source 12 electrically connected to a plasma torch assembly 312. A tip assembly 314 is removably connected to a torch body or a handle portion 316 and has a nozzle 318 disposed about an electrode 320. A shuttle element 322 is disposed between electrode 320 and nozzle 318 and can be electrically connected to one of the electrode and the nozzle, or to neither as shown in FIG. 11. Controller 50 communicates with plasma torch assembly 312 and includes pilot arc circuit 52 and cutting arc circuit 54. Controller 50 also communicates with biasing means controller 51 of plasma torch assembly 312. Controller 50 is connected to plasma torch assembly 312 by a plurality of cables 328 and a hose 330. Cables 328 communicate pilot arc power and cutting arc power to torch assembly 312. Additionally, cables 328 can be configured to communicate operational feedback from torch assembly 312 to power source 12. Hose 330 communicates a gas to torch assembly 312 for operation of shuttle element 322, gas for the generation of plasma for a cutting process, and provides cooling gas when desired. A cable 332 electrically connects a workpiece 334 to power source 12 through clamp 336.

Upon trigger actuation, biasing means controller 51 initiates a flow of gas 338 to momentarily bias shuttle element 322 into mutual contact with both nozzle 318 and electrode 320. Controller 50 enables pilot arc circuit 51 and communicates a power signal sufficient to generate a pilot arc to electrode 320 and nozzle 318 via shuttle element 322. Biasing means controller 51 then suspends flow of gas 338 allowing shuttle element 322 to return to a first position wherein the shuttle element is not in mutual contact with electrode 320 and nozzle 318. The return of shuttle element 322 to the first position generates a pilot arc between the electrode/nozzle and the shuttle element. A flow of gas is directed through torch assembly 312 and carries the pilot arc to workpiece 334. Operational feedback communicated to power source 12 or controller 50 indicates the extension of the pilot arc to workpiece 334. Controller 50 then enables a cutting arc circuit 54 and communicates a cutting arc power from power source 12 to electrode 320.

Therefore, one embodiment of the present invention includes a plasma torch having a nozzle positioned about an electrode. A shuttle element is disposed between the nozzle and the electrode and movable between a first position and a second position. The shuttle element is separated from at least one of the nozzle and the electrode when in the first position and contacts the nozzle and the electrode when in the second position. The plasma torch includes a biasing means constructed to bias the shuttle element to the first position during an idle mode and a cutting mode of the plasma torch.

Another embodiment of the present invention includes a plasma cutting system having a plasma torch connected to a power source constructed to generate a power signal suitable for plasma cutting applications. The plasma torch includes a cathodic component having a fixed-position and an anodic component having a fixed-position. A separator is movably disposed between the cathodic component and the anodic component. A first biasing means is connected to the plasma torch and is constructed to bias the separator out of mutual contact with the cathodic component and the anodic component. A second biasing means is connected to the plasma torch and constructed to overcome the first biasing means and move the separator into mutual contact with the cathodic component and the anodic component.

A further embodiment of the present invention includes a method of initiating a plasma arc comprising the steps of biasing a shuttle element housed in a plasma torch to maintain a separation between a cathode and an anode, overcoming the bias to connect the shuttle element to the cathode and the anode, and returning the shuttle element to the biased position to generate a plasma arc.

As one skilled in the art will fully appreciate, the heretofore description of a plasma cutting system is one example of a plasma cutting system according to the present invention. It is understood that torches having constructions other than those shown are envisioned and within the scope of the claims.

The present invention has been described in terms of the preferred embodiment, and it is recognized that equivalents, alternatives, and modifications, aside from those expressly stated, are possible and within the scope of the appending claims.

1. A plasma torch comprising:
an electrode;
a nozzle positioned about the electrode;
a shuttle element disposed between the nozzle and the electrode and movable between a first position and a second position, the shuttle element separated from at least one of the nozzle and the electrode when in the first position and contacting the nozzle and the electrode when in the second position; and
biasing means constructed to bias the shuttle element to the first position during an idle mode and a cutting mode of the plasma torch.

2. The plasma torch of claim 1 further comprising an overcoming means constructed to overcome the biasing means and move the shuttle element to the second position upon a trigger actuation.

3. The plasma torch of claim 2 wherein at least one of the biasing means and the overcoming means is at least one of a gas flow, a spring, and a solenoid.

4. The plasma torch of claim 1 wherein the biasing means is further defined as a spring and the spring is fixedly connected to the shuttle element and at least one of the electrode and the nozzle.

5. The plasma torch of claim 1 further comprising a power source connectable to the plasma torch and constructed to provide a plasma cutting power to the plasma torch and a gas source constructed to provide a plasma/cooling gas to the plasma torch.

6. The plasma torch of claim 1 further comprising a control having a pilot arc circuit and a cutting arc circuit, the pilot arc circuit constructed to provide a power signal sufficient to generate an electrical arc between the shuttle element and one of the nozzle and electrode when the shuttle element moves from the second position to the first position.

7. The plasma torch of claim 1 wherein the idle mode is further defined as the plasma torch being arc-less and the cutting mode is further defined as the plasma torch communicating an arc to a workpiece.

8. The plasma torch of claim 1 wherein the shuttle element is electrically isolated from the nozzle when located in the first position.

9. A plasma cutting system comprising:
a power source constructed to generate a power signal suitable for plasma cutting applications;
a plasma torch connected to the power source and having a cathodic component having a fixed-position, an anodic component having a fixed-position, and a separator movably disposed between the cathodic component and the anodic component;
a first biasing means connected to the plasma torch and constructed to bias the separator out of mutual contact with the cathodic component and the anodic component; and
a second biasing means connected to the plasma torch and constructed to overcome the first biasing means and move the separator into mutual contact with the cathodic component and the anodic component.

10. The plasma cutting system of claim 9 wherein the first biasing means is at least one of a solenoid, a spring, and a gas flow.

11. The plasma cutting system of claim 9 wherein the second biasing means is at least one of a solenoid, a spring, and a gas flow.

12. The plasma cutting system of claim 9 wherein the first biasing means is a spring, the spring electrically connecting the separator and one of the anodic component and the cathodic component.

13. The plasma cutting system of 12 wherein the spring is housed in a recess formed in the one of the anodic component and the cathodic component.

14. The plasma cutting system of claim 9 further comprising a first gas passage formed through the plasma torch and constructed to supply a plasma forming gas and a second gas passage formed through the plasma torch and constructed to provide the second biasing means to the plasma torch.

15. The plasma cutting system of claim 9 wherein the separator bridgingly connects the anodic component and cathodic component during an arc requested mode and electrically separates the cathodic component and the anodic component during an arc-less mode and a cutting mode.

16. The plasma cutting system of claim 9 further comprising a trigger attached to the plasma torch and constructed to initiate the second biasing means automatically upon each actuation of the trigger, the second biasing means configured to be overcome by the first biasing means after the separator has established mutual contact with the cathodic component and the anodic component.

17. The plasma cutting system of claim 9 wherein the separator is electrically isolated from the anodic component when the separator is out of contact therewith.

18. A method of initiating a plasma arc comprising the steps of:
positioning a shuttle element substantially about a circumference of an electrode in a plasma torch;
biasing the shuttle element housed in a plasma torch to maintain a separation between a cathode and an anode;
overcoming the bias to connect the shuttle element to the cathode and the anode; and
returning the shuttle element to the biased position to generate a plasma arc.

19. The method of claim 18 wherein the step of biasing the shuttle element is achieved with at least one of a spring, a gas flow, and a solenoid.

20. The method of claim 18 wherein the step of overcoming the bias is achieved with at least one of a spring, a gas flow, and a solenoid.

21. The method of claim 18 further comprising the step of actuating a trigger to initiate the step of overcoming the bias.

22. The method of claim 18 further comprising connecting the cathode and the anode to a power source constructed to generate a plasma cutting power.

23. The method of claim 18 wherein the step of biasing the shuttle element further comprises electrically separating the shuttle element and the anode.
